(19) United States
(12) Patent Application Publication
(10) Pub. No.: US 2011/0137215 A1
(43) Pub. Date: Jun. 9, 2011

(54) Apparatus and Method for Knee Rehabilitation

(76) Inventor: Daniel LeBlanc, Deerfield, NH (US)

(21) Appl. No.: 12/960,864

(22) Filed: Dec. 6, 2010

Related U.S. Application Data
(60) Provisional application No. 61/283,637, filed on Dec. 7, 2009.

(51) Int. Cl. A61H 1/02

(52) U.S. Cl. 601/5

(57) ABSTRACT

A knee rehabilitation device for assisting in the movement of a leg has a longitudinal bar and a lower and upper leg engaging bar. The lower leg engaging bar extends perpendicular from the longitudinal bar and is for engaging the leg of the user. The upper leg engaging bar is carried by the longitudinal bar and is for engaging the leg of the user. The device has a base portion secured to the longitudinal bar. The base portion has rotatable devices for movement of the device relative to a surface. A handle is connected to the longitudinal portion. The handle has a hand engaging portion for the user to engage to facilitate movement of the device. The hand engaging portion projects from the extension portion and is generally parallel to the pivot location and the pair of leg engaging bars. The leg of the user below the knee engages both the lower leg engaging bar and the upper leg engaging bar.

### CROSS-REFERENCE TO RELATED APPLICATIONS

This application claims the benefit of Provisional Patent Application 61/283,637 filed on Dec. 7, 2009, which is incorporated herein by reference.

### TECHNICAL FIELD

The present invention relates to an exercise or rehabilitation device and more particularly, to an apparatus and method for exercising and stretching muscles in the knee region.

### BACKGROUND INFORMATION

Persons condition, stretch, and exercise muscles for numerous reasons. A professional football player and a person with a replacement knee have different goals and requirements. With respect to a person with a replacement knee, the emphasis in the early and latter stages of rehab is to regain range of motion of the affected leg and to ensure that the patient can walk safely. After the surgery to install the replacement knee, the body reacts to surgery by making scar tissue. If the patient does not focus on bending and straightening their leg in the days, weeks, and months after surgery, the patient may never recover normal range of motion. While a physical therapist will work on mobility, strengthening, and walking in the hospital and during scheduled rehabilitation periods, it is necessary that the patient work on their own.

One shortcoming of most conventional devices is that they require the user to be in a prone position, such as lying in bed, increasing the risk of an embolism. Another shortcoming is that for devices that allow the user to be sitting, the user needs to move around to don the device. Also, most do not allow for both extension and flexion motions or the ability to strengthen muscles simultaneously.

Accordingly, there is a need for a device that allows a user to quickly and safely don and exit the device without manipulation and to offer both extension and flexion capabilities and the ability to strengthen muscles simultaneously. Furthermore, it is desired that the device be light-weight, compact, inexpensive, and easy to store.

### SUMMARY

In accordance with one aspect of the present invention, a knee rehabilitation device for assisting in the movement of a leg has a longitudinal bar and a lower and upper leg engaging bar. The lower leg engaging bar extends perpendicular from the longitudinal bar and is for engaging the leg of the user. The upper leg engaging bar is carried by the longitudinal bar and is for engaging the leg of the user. The device has a base portion secured to the longitudinal bar. The base portion has rotatable devices for movement of the device relative to a surface. A handle is connected to the longitudinal portion. The handle has a hand engaging portion for the user to engage to facilitate movement of the device. The hand engaging portion projects from the extension portion and is generally parallel to the pivot location and the pair of leg engaging bars. The leg of the user below the knee engages both the lower leg engaging bar and the upper leg engaging bar.

In an embodiment, the handle is connected to the longitudinal portion and has a hand engaging portion adapted for the user to engage to assist in movement of the leg. In an embodiment, the handle has an extension portion that extends from the longitudinal bar to the hand engaging portion. The hand engaging portion projects from the extension portion and is generally parallel to the pivot location and the pair of leg engaging bars wherein the leg of the user below the knee engages the lower leg engaging bar and the upper leg engaging bar.

In an embodiment, the engaging bars are adjustable relative to the longitudinal bar.

In an embodiment, the device has a progress gauge having an indicator to provide an indication of range of motion of the leg relative to the knee region.

In an embodiment, the longitudinal bar has an upper longitudinal bar portion and a lower longitudinal bar portion. The bar portions are offset from each other such that they are parallel but aligned.

In an embodiment, the upper leg engaging bar has a “V” shaped portion for engaging the leg and maintaining proper leg alignment relative to the normal path of leg movement in the extension and flexion exercises.

In an embodiment, the base has a pair of rotational axes spaced apart and defines a platform for the foot of the user.

In accordance with one method of rehabilitating a knee according to the invention, a leg of the user is placed in engagement with a knee rehabilitation device. The device has a pair of leg engaging bars such that one leg engaging bar engages the back of the leg between the foot of the user and the knee and the other leg engaging bar engages the front of the leg between the foot of the user and the knee. The positions of the leg engaging bars are adjusted relative to a longitudinal bar such that the leg engaging bars engage the leg of the user in proximity to the ankle and in proximity to the knee. A handle which is connected to the longitudinal bar is engaged and moved such that the leg engaging bars move and both of the bars exert force on the leg resulting in stretching of a set of muscles of the user.

In one method, the user places their leg such that the upper leg engaging bar engages the front of the leg and the lower leg engaging bar engages the back of the leg in proximity to the ankle. The leg is moved from a generally bent position to a straight position such that the extension stretches the muscles on the back of the leg.

In one method, the user places their leg such that the upper leg engaging bar engages the back of the leg and lower leg engaging bar engages the front of the leg in proximity to the ankle. The leg is moved from a generally straight position to a bent position such that the flexion stretches the muscles on the front of the leg.

In one embodiment, a knee rehabilitation device for assisting in the movement of a leg has a longitudinal bar. The longitudinal bar has a lower longitudinal bar portion and an upper longitudinal bar portion. The bar portions are offset from each other by an offset section such that the bar portions are generally parallel and offset from each other. The device has a lower leg engaging bar and an upper leg engaging bar. The lower leg engaging bar extends perpendicular from the longitudinal bar. The lower leg engaging bar has a mounting portion and rotatable cylindrical leg engaging portion. The upper leg engaging bar has a mounting portion and a “V” shaped leg engaging portion rotatably mounted to the mounting portion. A base portion of the device is secured to the longitudinal bar. The base portion has two foot supports and a pair of rotatable devices. Each rotatable device is rotatable about its own rotational axis generally parallel to each other and the lower leg engaging bar and the “V” shaped leg engaging portion of the upper leg engaging bar. The device has a handle having an extension portion that connects to the longitudinal portion and a hand engaging portion. The hand engaging portion projects from the extension portion and is generally parallel to the pivot location and the pair of leg engaging bars.

These aspects of the invention are not meant to be exclusive and other features, aspects, and advantages of the present invention will be readily apparent to those of ordinary skill in the art when read in conjunction with the following description, appended claims and accompanying drawings.

### BRIEF DESCRIPTION OF THE DRAWINGS

The foregoing and other objects, features, and advantages of the invention will be apparent from the following description of particular embodiments of the invention, as illustrated in the accompanying drawings in which like reference characters refer to the same parts throughout the different views. The drawings are not necessarily to scale, emphasis instead being placed upon illustrating the principles of the invention.

FIG. 1 is a right side view of the knee rehabilitation device of the present invention;

FIG. 2 is a left side view of the knee rehabilitation device of the present invention;

FIG. 3 is a front view of the knee rehabilitation device of the present invention;

FIG. 4 is a back view of the knee rehabilitation device of the present invention;

FIGS. 5A-5C show the knee rehabilitation device for extension, stretching the muscles on the back of the leg;

FIGS. 6A-6C show the knee rehabilitation device for flexion, stretching the muscles on the front of the leg;

FIG. 7A is a side view of a portion of the knee rehabilitation device showing a progress gauge;

FIG. 7A1 is a front view of the progress gauge detached from the remainder of the knee rehabilitation device;

FIG. 7B is a side sectional view of the progress gauge; and

FIG. 7C is a sectional view of the progress gauge.

### DETAILED DESCRIPTION OF THE PREFERRED EMBODIMENTS

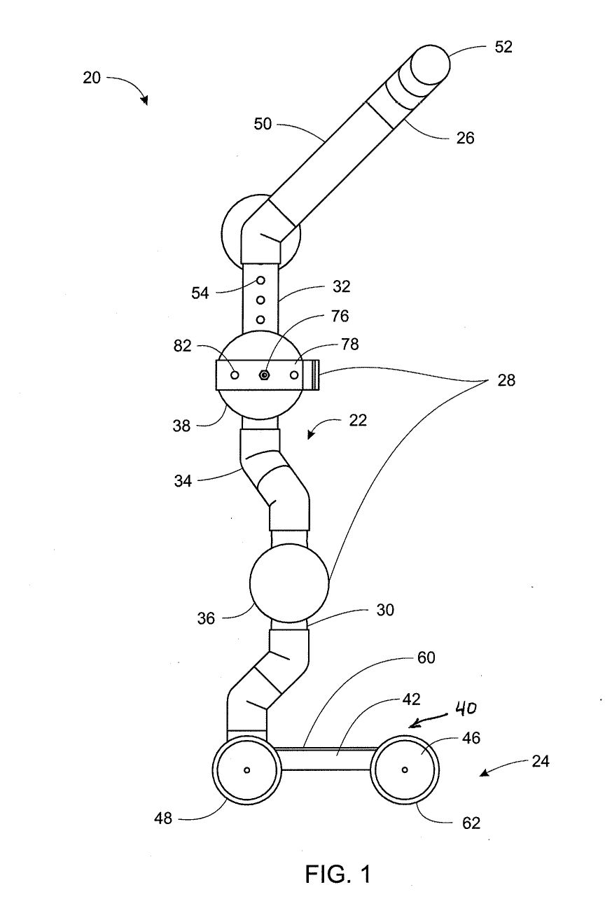

Referring to FIG. 1, a right side view of the knee rehabilitation device 20 is shown. The knee rehabilitation device 20 has a longitudinal bar 22, a base 24, a handle 26, and a pair of leg engaging bars 28. The longitudinal bar 22 has a lower longitudinal bar portion 30 and an upper longitudinal bar portion 32. The longitudinal bar portions 30 and 32 are parallel to each other and offset from being along the same longitudinal axis by an offset section 34.

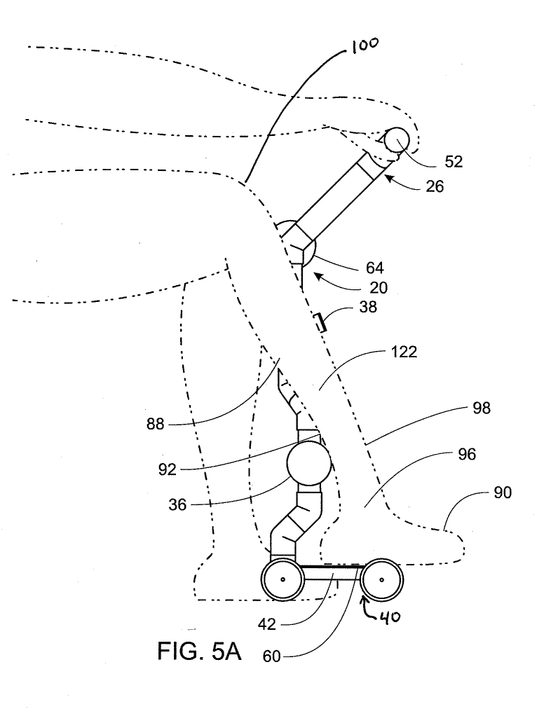

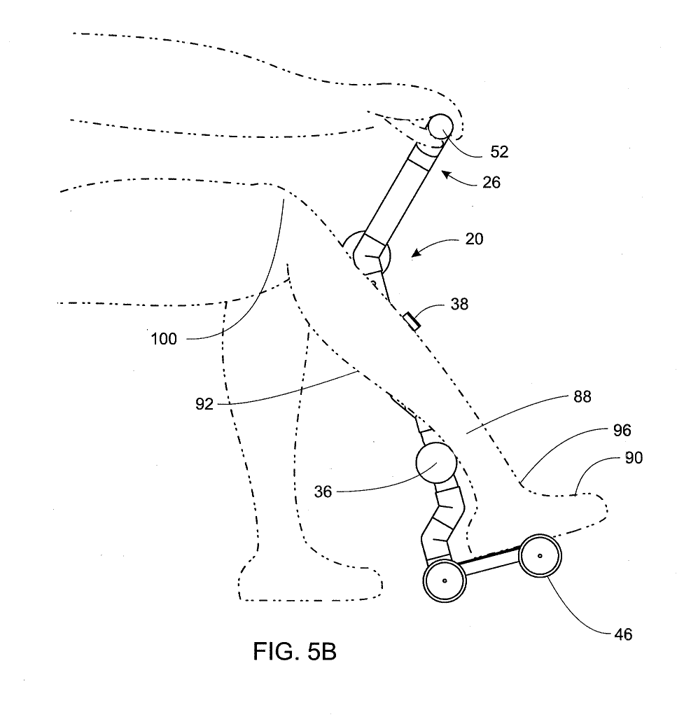

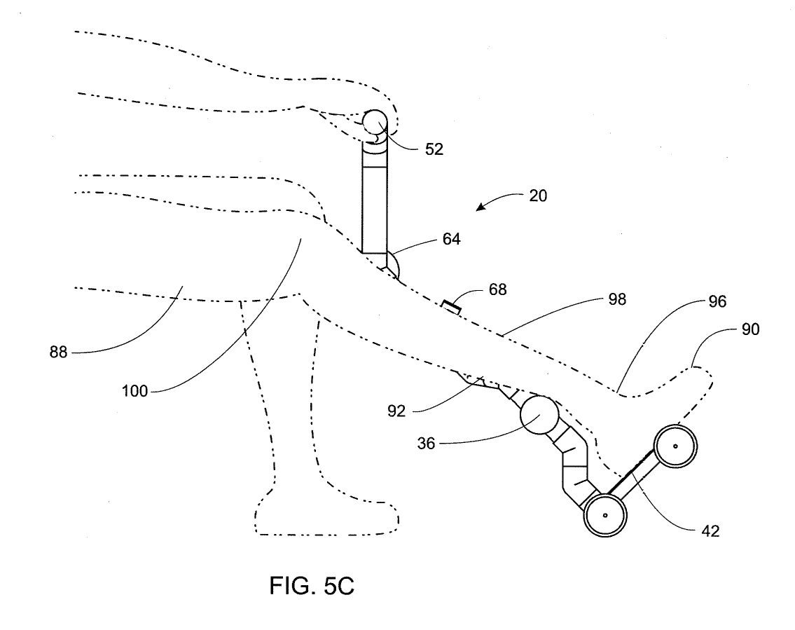

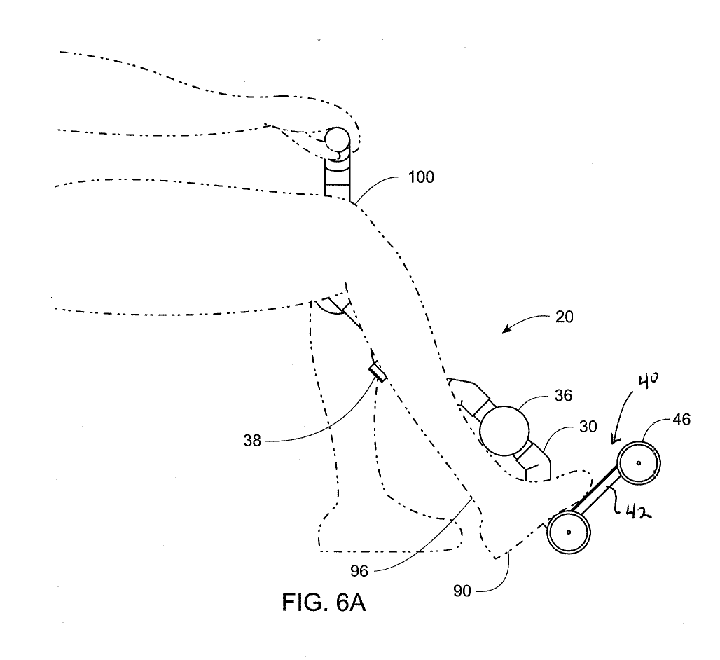

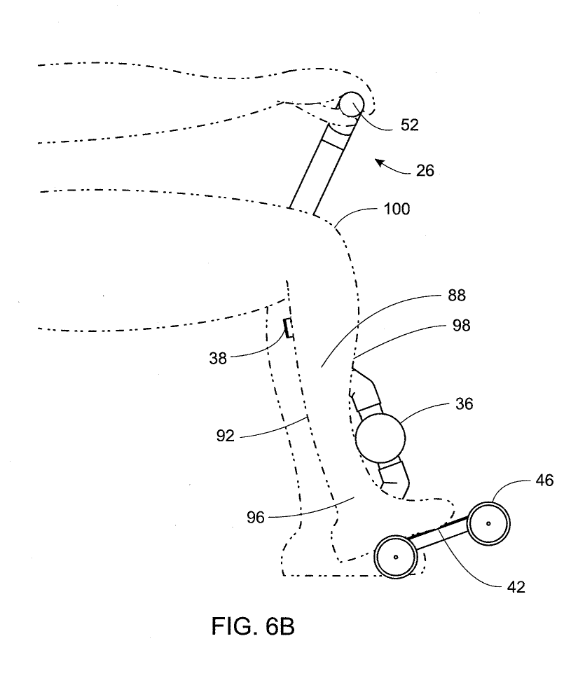

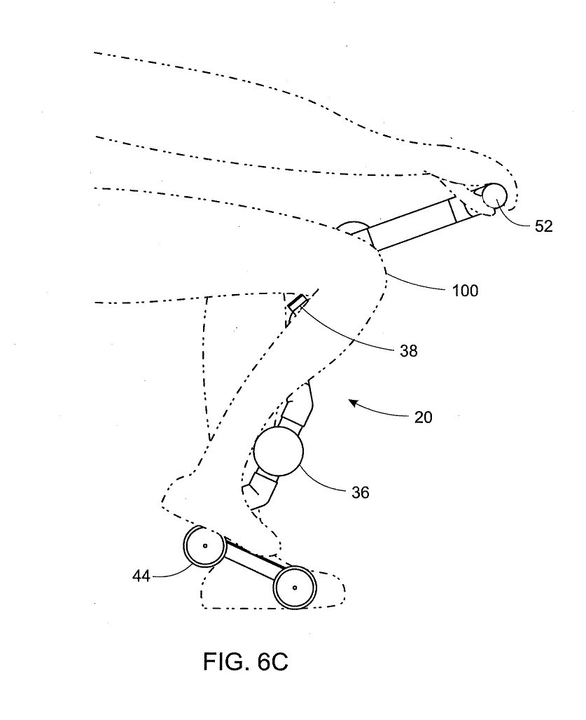

The pair of leg engaging bars 28 has a lower engaging bar 36 projecting from the lower longitudinal bar portion 30 and an upper leg engaging bar 38 projecting from the upper longitudinal bar portion 32. The leg engaging bars 28 are adjustable such that one of the leg engaging bars 28 engages the front of the leg and the other engages the back of the leg as seen in FIGS. 5A-5C and 6A-6C.

The base 24 is connected to the lower longitudinal bar portion 30 of the longitudinal bar 22. The base 24 has a pair of foot supports 40 which are generally perpendicular to the longitudinal bar 22 and generally parallel to the lower leg engaging bar 36 and the upper leg engaging bar 38. Interposed between the two foot supports 40 is an extension, base extension 42. The base extension 42 spaces the two foot supports 40. In the embodiment shown, a platform 60 overlies the foot supports 40 and the base extension 42; the foot 90 of the user as seen in FIGS. 5A-5C is positioned on top of the platform 60.

Each foot support 40 further defines a rotational axis 44 upon which a set of wheels 46 rotates. The set of wheels 46 underlying the lower longitudinal bar portion 30 defines a pivot point 48 of the knee rehabilitation device 20.

The handle 26 has an extension portion 50 and a hand engaging portion 52. The extension portion 50 of the handle 26 extends from the upper longitudinal bar portion 32 to the hand engaging portion 52, which projects perpendicular from the upper arm 26 and is generally parallel to the pair of engaging bars 36 and 38.

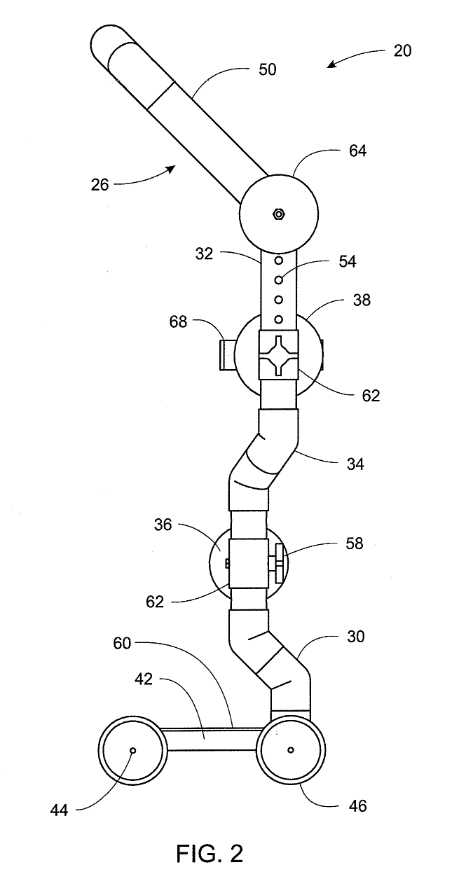

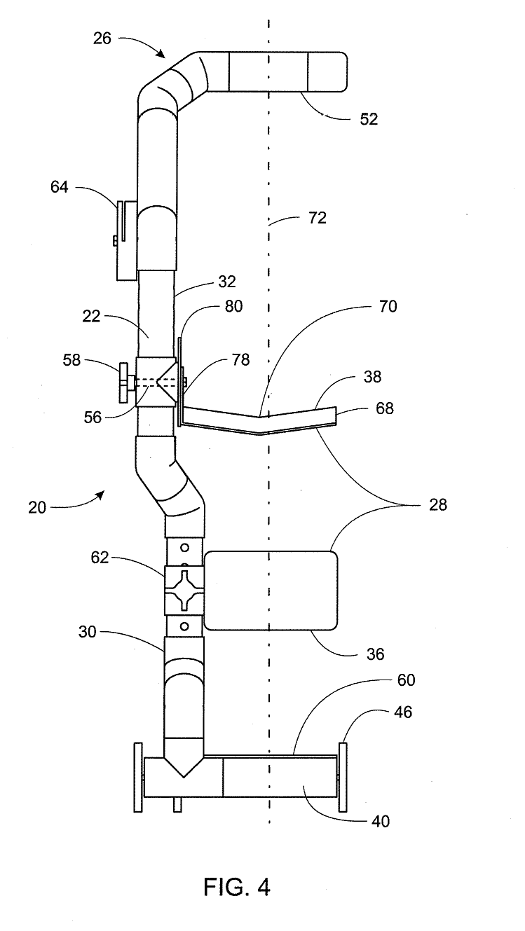

Referring to FIG. 2, the left side view of the knee rehabilitation device 20 is shown. The engaging bars 36 and 38 are adjustable in the vertical direction relative to the respective longitudinal bar portions 30 and 32. In the embodiment shown, the longitudinal bar portions 30 and 32 have a series of holes 54 as best seen in the upper longitudinal bar 32 for receiving a pin 56, as best seen in hidden line in FIG. 4, attached to a handle 58. Each leg engaging bar 28 has a sleeve 62 that encircles the longitudinal bar 22. The leg engaging bar 28 can be adjusted by moving the sleeve 62 upwards or downwards and reinserting the handle 58 to the proper hole 54.

It is recognized that an alternative arrangement to the handle 58 and the pin 56 being one component is the pin 56 being part of the leg engaging bar 28 and there being a threaded engagement with the handle 58 to secure the sleeve 62 in the proper position.

The knee rehabilitation device 20, in addition, has a progress gauge 64. The progress gauge 64 is located at the connection point between the longitudinal bar 22 and the extension portion 50 of the handle 26. In one embodiment, the progress gauge 64 is adjustable so that it aligns horizontally with the knee joint for the purpose of monitoring the user's progress in terms of gain in the degree of leg extension and flexion during operation and over a prescribed time period as it will be further explained with respect to FIGS. 5A-5C and FIGS. 6A-6C.

In an alternative arrangement, the progress gauge 64 is fixed at a set position relative to the longitudinal bar 22. As explained below, the progress gauge 64 is for the user to get a measurable determination of progress and the added complexity of adjustability is not required for the accuracy needed for the measurable determination.

Still referring to FIG. 2, the upper longitudinal bar portion 32 is shown in the orientation that is used for leg extension, the position where the user is in flexion, that is stretching the muscles on the front of the leg.

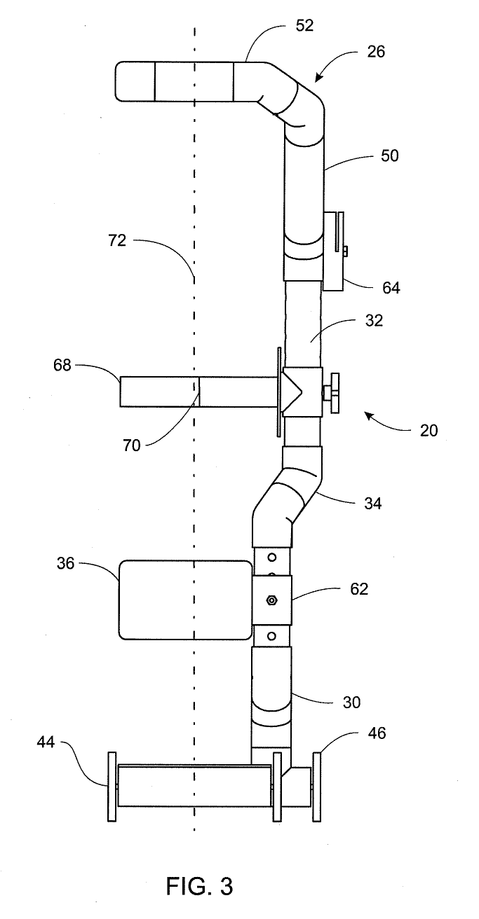

Referring to FIG. 3, a front view of the knee rehabilitation device 20 is shown. The upper longitudinal bar portion 32 is shown in the leg extension position. The upper longitudinal bar portion 32 has a “V” shape 68, as best seen in FIG. 4. The center 70 of the “V” aligns in the vertical direction with the hand engaging portion 52 and the base extension 42 as shown by vertical line 72.

The offset section between the lower longitudinal bar portion 30 and the upper longitudinal bar portion 32 allows the upper longitudinal bar portion 32 to be spaced further from the vertical line 72. It is recognized that the thigh of a user is generally wider than the lower leg and the offset section 34 tailors the knee rehabilitation device 20 for these physiological differences.

Referring to FIG. 4, a back view of the knee rehabilitation device 20 is shown. The upper leg engaging bar portion 32 is shown with the center 70 of the “V” shape 68 rotated downward, which is not a position that is set for use. To allow rotation and positioning of the “V” shape of the upper longitudinal bar portion 32, the “V” shape 68 is spaced from a pivot 76 by an extension 78. The upper longitudinal bar portion 32 has a circular disc 80 for minimizing flexure of the extension 78.

As indicated above, with respect to FIG. 2, the leg engaging bars 28 each have a sleeve 62 that encircles the longitudinal bar 22. A pin 56 extends through the holes 54 in the longitudinal bar 22 and in a pair of holes 76 in the sleeve 62 to position the leg engaging bar 28. The pin 56 is removed and the leg engaging bar 28 with the sleeve 62 is positioned such that the holes 86 in the sleeve 62 align with one of the set of holes 54 in the longitudinal bar 22. The pin 56 is inserted and secured. While the upper leg engaging bar 38 with the upper longitudinal bar portion 32 is shown in section, the lower leg engaging bar 36 with the lower longitudinal bar portion 30 are similarly constructed.

The upper leg engaging bar 38 is also adjustable in order to move the “V” shape 68 lateral relative to the pivot 76. The extension 78, in the embodiment shown, has a series of holes 82, as best seen in FIG. 1, through which the pin 56 can be placed. Depending on the hole 82 selected, the “V” shape 68 can be moved to accommodate various size users and in particular their calf.

Referring to FIGS. 5A-5C, the knee rehabilitation device 20 is shown for the leg extensions which stretches the muscles on the back side of the leg 88. The user can either take the rehabilitation device 20 to her seat or she is already seated and is given the device 20. While the device 20 can be used on either leg, the device is shown on the user's right leg. The user places her foot 90 on the foot supports 40 of the base 24 with the back 92 of her lower leg 94 engaging the lower leg engaging bar 36. The lower leg engaging bar 36 is positioned using the handle 58 as best seen in FIG. 4 such that the lower leg engaging bar 36 is located in proximity to the ankle 96 of the user. The upper leg engaging bar 38 engages the front 98 of the lower leg 94 slightly below the knee 100. As indicated above, the upper leg engaging bar 38 with the sleeve 62 is adjustable so that it can move vertically by placing the pin 56 in the proper holes 54 in the longitudinal bar 22. In addition, the upper leg engaging bar 38 is rotatable about the pivot 76 such that the “V” shape 68 is properly aligned.

Still referring to FIG. 5A, the user grabs the hand engaging portion 52 of the handle 26 and pulls the handle towards her creating a force on the lower leg engaging bar 36 against the back of the ankle 96 moving the foot 90 on the base 24 away from the torso of her body. FIGS. 5B and 5C, show the leg as the leg is extended. The intersection of the handle 26 and the longitudinal bar 22 is located in alignment with the knee 100 in the figures shown. However, it is the position of the engaging bars 36 and 38 that is relevant and not the intersection of the handle 26 to the longitudinal bar 22. In the embodiment shown, the location of the progress gauge 64 can be adjusted to position it such that the progress gauge 64 is located to line up in the horizontal position with the knee.

As indicated above with respect to FIG. 3, the center 70 of the “V” aligns in the vertical direction with the hand engaging portion 52 and the base extension 42 as shown by vertical line 72. This alignment keeps the leg 88 properly aligned when using the knee rehabilitation device 20.

Referring to FIGS. 6A-6C, the knee rehabilitation device 20 is shown for flexing the leg therein stretching the muscles on the front side of the leg 88. The user places the front of the ankle 96 in engagement with the lower leg engaging bar 36. The foot 90 is located on top of the base 24 on the foot support 40 which is the rotational axis 44. The base 24 has two foot supports 40 spaced by the extension base 42 such that the foot is supported in both the extension position of FIGS. 5A-5C and the flexion position of FIGS. 6A-6C.

The upper leg engaging bar 38 is positioned on the back of the leg 92, the calf, such that it is in the calf region and below the knee 76. The user takes the hand engaging portion 28 and pushes it away from her chest therein moving the lower leg 74 generally below the knee 76.

It is the lower leg engaging portion 30 that exerts pressure on the front of the leg 98 as the user pushes the hand engaging portion 52 away from her chest. The “V” shape 68 of the upper leg engaging bar 38, which has been positioned generally in a 180° position from that in FIGS. 5A-5C, positions the upper portion of the lower leg 94.

As seen in FIGS. 5A-6C, there is a moving pivot point 122 defined as the center point between the interaction of the leg 88 with the engaging bars 28. In that the upper engaging bar 36 and the lower engaging bar 38 engage the leg 88 on opposite sides of the leg 88, the moving pivot point 122 defines a moment arm. As the user moves their leg 88, the base 24 with the two sets of wheels 46 has the interaction with the foot 90 shift from near one set of wheels 46 to the other set of wheels 46. For example, referring to FIG. 5A, while the weight of the leg 88 is fairly evenly distributed on the base 24, the center point of the weight is near the front set of wheels 46. Whereas in FIG. 5C, the center point of the weight has shifted to near the back set of wheels.

The knee rehabilitation device 20, in addition to assisting the user in increasing range of motion of the leg 88, assists the user in strengthening the muscles of the leg 88 by creating resistance as the user moves the device 20 by pushing or pulling the hand engaging portion 52. As the device 20 rolls on the wheels 46, the engaging bars 28 push, create resistance, against the leg 88.

Referring to FIG. 2, the offset section 34 spaces the upper longitudinal bar portion 32 such that it is forward of the lower longitudinal bar portion 30. Referring to FIG. 3, it is seen that the offset section 34, in addition, off sets the upper longitudinal bar portion 32 outward from the center of axis relative to the lower longitudinal bar portion 30. The position of the upper longitudinal bar portion 32 relative to the lower longitudinal bar portion 30 is such that it accommodates the upper portion of the user's leg which is generally wider than the lower portion. Therefore, the upper leg engaging bar 38 is capable of fitting the calf of the leg.

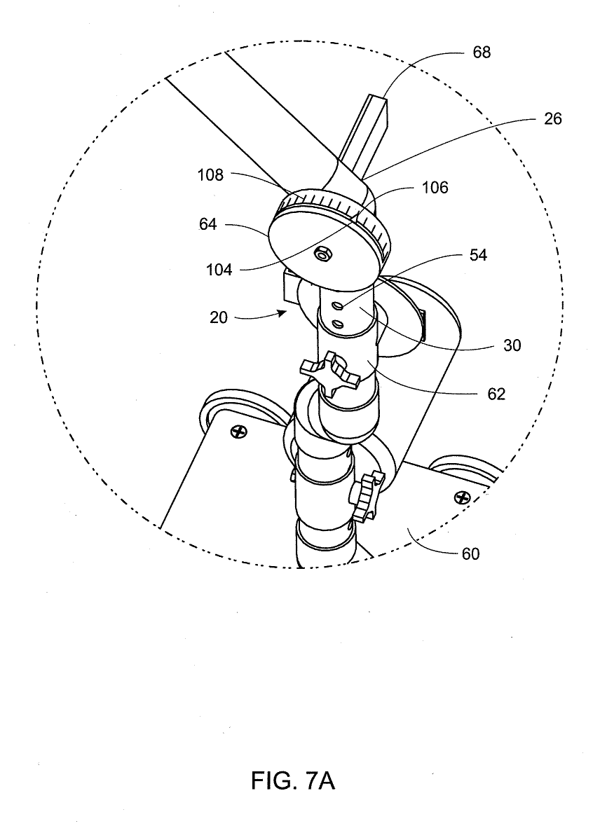

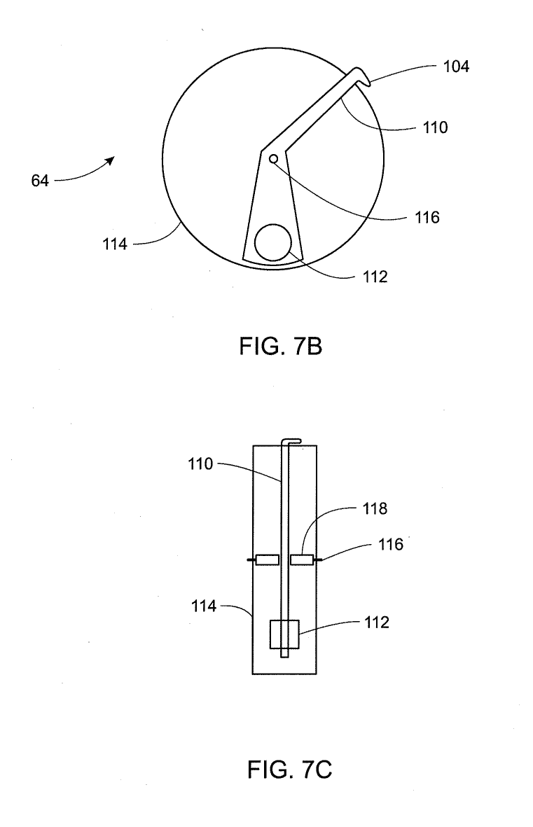

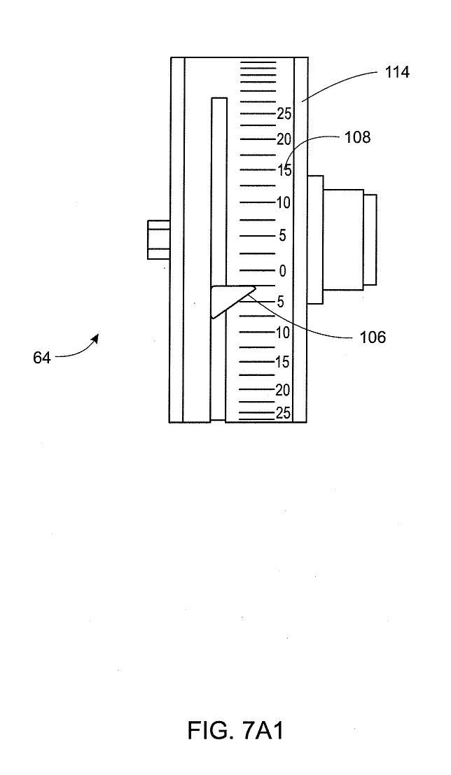

Referring to FIG. 7A, a side view of a portion of the knee rehabilitation device 20 including the progress gauge 64 is shown. In the embodiment shown, the progress gauge 64 is mounted to the handle 26 by an extension 102. The progress gauge 64 has an indicator 104 that includes a pointer 106 and number scale 108 that shows graduation markings.

Referring to FIGS. 7B and 7C, sectional views of the progress gauge 64 are shown. The pointer 106 is part of a bar 110 that has a weight 112 at the other end of the bar 110. The bar 110 is pivotably mounted in a housing 114 of the progress gauge 64 at a pivotal axis 116. A pair of spacers 118 positions the bar 110 within the housing 114.

As the user operates the device 20, the user can see generally how much flexion or extension is occurring. As indicated above, the purpose of the progress gauge 64 is to provide a measurable determination of the leg's flexion or extension.

It is recognized that while the bar 110 of the progress gauge 64 is shown with the two portions coming off the pivot axis 116 at an angle relative to each other, the two portions of the bar 110 could be parallel and aligned with each other. In addition, the number scale 108 that the user views in relation to the pointer 106 can vary in number of marks over a set length. In addition, symbols may be used in place of numbers to assist the user in determining how much flexion or extension is occurring.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention.

It is recognized that an alternative arrangement to the handle 58 and the pin 56 being one component is the pin 56 being part of the leg engaging bar 28 and in threaded engagement with the handle 58 to secure the sleeve 62 in the proper position.

It is recognized that other mechanisms can be used to adjust the leg engaging bar 28. For example, a locking collar or a snapping friction bar could be used to position the sleeve.

While the extension portion 50 of the handle 26 is shown at an angle of approximately 45° to the upper longitudinal bar portion 32, it recognized that the connection between the two can be adjustable. It is recognized that when the knee rehabilitation device 20 is activated for flexion, it may be desirable to move the hand engaging portion 52, as seen in FIGS. 6A-6C, closer to the body. Another alternative is to place an extension on the handle in proximity to the hand engaging portion.

What is claimed is:

1. A knee rehabilitation device for assisting in the movement of a leg, the device comprising
a longitudinal bar;
a lower leg engaging bar extending perpendicular from the longitudinal bar, the lower leg engaging bar for engaging the leg of the user;
an upper leg engaging bar carried by the longitudinal bar, the upper leg engaging bar for engaging the leg of the user; and
a base portion secured to the longitudinal bar, the base portion having rotatable devices for movement of the device relative to a surface.

2. A device of claim 1 further comprising a handle connected to the longitudinal portion, the handle having a hand engaging portion adapted for the user to engage to assist in movement of the leg.

3. A device of claim 2 wherein the handle has an extension portion that extends from the longitudinal bar to the hand engaging portion, the hand engaging portion projects from the extension portion and is generally parallel to the pivot location and the pair of leg engaging bars wherein the leg of the user below the knee engages the lower leg engaging bar and the upper leg engaging bar.

4. A device of claim 1 wherein the engaging bars are adjustable relative to the longitudinal bar.

5. A device of claim 1 further comprising a progress gauge having an indicator to provide an indication of range of motion of the knee.

6. A device of claim 1 wherein the longitudinal bar has an upper longitudinal bar portion and a lower longitudinal bar portion, the bar portions offset from each other such that the bar portions are parallel but not aligned.

7. A device of claim 1 wherein the upper leg engaging bar has a “V” shaped portion for engaging the leg.

8. A device of claim 1 wherein the base has a pair of rotational axes spaced apart and defines a platform for the foot of the user.

9. A method of bending the knee of a user comprising:
placing a leg of the user in engagement with a knee rehabilitation device having a pair of leg engaging bars such that one leg engaging bar engages the back of the leg between the foot of the user and the knee and the other leg engaging bar engages the front of the leg between the foot of the user and the knee;
adjusting the positions of the leg engaging bars relative to a longitudinal bar such that the leg engaging bars engage the leg of the user in proximity to the ankle and in proximity to the knee; and
engaging and moving a handle which is connected to the longitudinal bar such that the leg engaging bars move and both of the bars exert force on the leg resulting in stretching of a set of muscles of the user.

10. A method of claim 9 wherein the user places their leg such that the upper leg engaging bar engages the front of the leg and the lower leg engaging bar engages the back of the leg in proximity to the ankle; and further comprises moving the leg from a generally bent position to a straight position such that the extension stretches the muscles on the back of the leg.

11. A method of claim 9 wherein the user places their leg such that the upper leg engaging bar engages the back of the leg and lower leg engaging bar engages the front of the leg in proximity to the ankle, and further comprises
moving the leg from a generally straight position to bent position such that the flexion stretches the muscles on the front of the leg.

12. A method of claim 9 wherein the user looks at a progress gauge as they move their leg to determine the amount of flexure.

13. A knee rehabilitation device for assisting in the movement of a leg, the device comprising
a longitudinal bar, the longitudinal bar having a lower longitudinal bar portion and an upper longitudinal bar portion, the bar portions offset from each other by an offset section such that the bar portions are generally parallel and offset from each other;
a lower leg engaging bar extending perpendicular from the longitudinal bar, the lower leg engaging bar having a mounting portion and rotatable cylindrical leg engaging portion;
an upper leg engaging bar, the upper leg engaging bar having a mounting portion and a “V” shaped leg engaging portion rotatably mounted to the mounting portion;
a base portion secured to the longitudinal bar, the base portion having a dual foot support and a pair of rotatable devices, each rotatable device rotatable about its own rotational axis, the rotational axes generally parallel to each other and the lower leg engaging bar and the “V” shaped leg engaging portion of the upper leg engaging bar; and
a handle having an extension portion that connects to the longitudinal portion and a hand engaging portion, the hand engaging portion projecting from the extension portion and generally parallel to the pivot location and the pair of leg engaging bars wherein the leg of the user below the knee engages the lower leg engaging bar and the upper leg engaging bar.

14. A device of claim 13 further comprising a progress gauge having an indicator to provide an indication of range of motion of the leg.

15. A device of claim 13 wherein the leg engaging portions are adjustable relative to the longitudinal bar.
